(19) United States
(12) Patent Application Publication
(10) Pub. No.: US 2023/0024258 A1
(43) Pub. Date: Jan. 26, 2023

(54) SYSTEMS AND METHODS FOR ADVANCED WEARABLE ASSOCIATE STREAM DEVICES

(71) Applicant: Honda Motor Co., Ltd., Tokyo (JP)

(72) Inventors: Derrick Ian Cobb, Delaware, OH (US); Emil Ali Golshan, Marysville, OH (US); Michael A. Fischler, Roswell, GA (US)

(21) Appl. No.: 17/709,546

(22) Filed: Mar. 31, 2022

Related U.S. Application Data
(60) Provisional application No. 63/223,809, filed on Jul. 20, 2021.

(51) Int. Cl. G06T 7/00; G06T 19/00; G06V 10/764

(52) U.S. Cl. CPC G06T 7/0002; G06T 19/006; G06V 10/764; G06T 2207/20081

(57) ABSTRACT

A wearable inspection unit is provided. The wearable inspection unit includes at least one sensor configured to capture images based on a current view of the user, a media output component configured to display an augmented reality overlay to a user, and a controller. The controller is programmed to store a machine learning trained inspection model trained to recognize images of one or more components, receive a signal from the at least one sensor including a current image in the current view of the user, compare the current image to a trained inspection model to determine a classification code based on the comparison, determine a current step of a process being performed by the user based on the classification code, and provide a notification message to the user via the augmented reality overlay based on the current step of the process being performed by the user.

### CROSS-REFERENCE TO RELATED APPLICATIONS

This application claims priority to U.S. Provisional Patent Application Ser. No. 63/223,809, filed Jul. 20, 2021, entitled “SYSTEMS AND METHODS FOR ADVANCED WEARABLE ASSOCIATE STREAM DEVICES,” the entire contents and disclosures of which are hereby incorporated herein by reference in its entirety.

### BACKGROUND

The field of the present disclosure relates generally to wearable devices and, more specifically, to associate wearable streaming classification devices.

Many inspection tools require the use of statically located inspection stations, where the inspection is done at one particular angle. Furthermore, some inspection tools only view the completed device or portion of a device and not the process of manufacturing the device itself. Accordingly, there is a need for a more flexible and efficient inspection tools for manufacturing environments.

### BRIEF DESCRIPTION

In one aspect, a wearable inspection device is provided. The wearable inspection device includes at least one sensor configured to capture images based on a current view of a user, a media output component configured to display an augmented reality overlay to the user, and a controller comprising at least one processor in communication with at least one memory device. The controller is in communication with the at least one sensor and the media output component. The at least one processor is programmed to store a machine learning trained inspection model. The trained inspection model is trained to recognize images of one or more components. The at least one processor is also programmed to receive a signal from the at least one sensor including a current image in the current view of the user. The at least one processor is further programmed to compare the current image to the trained inspection model to determine a classification code based on the comparison. In addition, the at least one processor is programmed to determine a current step of a process being performed by the user based on the classification code. Moreover, the at least one processor is programmed to provide a notification message to the user via augmented reality overlay based on the current step of the process being performed by the user.

In another aspect, a system is provided. The system includes a wearable including at least one sensor configured to capture images based on a current view of a wearer, a media output component configured to display an augmented reality overlay to the wearer, and a controller in communication with the wearable. The controller includes at least one processor in communication with at least one memory device. The at least one processor is programmed to store a machine learning trained inspection model. The trained inspection model is trained to recognize images of one or more components. The at least one processor is also programmed to receive a signal from the at least one sensor including a current image in the current view of the wearer. The at least one processor is further programmed to compare the current image to the trained inspection model to determine a classification code based on the comparison. In addition, the at least one processor is programmed to determine a current step of a process being performed by the wearer based on the classification code. Moreover, the at least one processor is programmed to provide a notification message to the wearer via the augmented reality overlay based on the current step of the process being performed by the wearer.

In another aspect, a method for inspecting is provided. The method is implemented by a computing device comprising at least one processor in communication with at least one memory device. The computing device is in communication with at least one sensor. The method includes storing a machine learning trained inspection model. The trained inspection model is trained to recognize images of one or more components. The method also includes receiving a signal from at least one sensor including a current image in a current view of a user. The method further includes comparing the current image to the trained inspection model to determine a classification code based on the comparison. In addition, the method includes determining a current step of a process being performed by the user based on the classification code. Furthermore, the method includes providing a notification message to the user via an augmented reality overlay based on the current step of the process being performed by the user.

### BRIEF DESCRIPTION OF THE DRAWINGS

FIG. 1 illustrates an inspection system training for inspecting during installation of a part in accordance with one example of the present disclosure.

FIG. 2 illustrates a block diagram of the inspection system shown in FIG. 1 in accordance with one example of the present disclosure.

FIG. 3 illustrates a process for using the inspection system shown in FIG. 2, in accordance with at least one example.

FIG. 4 illustrates an example configuration of user computer device used in the inspection system shown in FIG. 2, in accordance with one example of the present disclosure.

FIG. 5 illustrates an example configuration of a server computer device used in the inspection system shown in FIG. 2, in accordance with one example of the present disclosure.

### DETAILED DESCRIPTION

The field of the present disclosure relates generally to wearable devices and, more specifically, to integrating wearable devices into inspection systems.

In particular, the inspection system includes a wearable device, worn by a user while installing and/or repairing a device. The wearable device includes at least a camera or other optical sensor to view objects in the direction that the user is looking. The wearable device can also include a screen or other display device to display information to the user. In at least one embodiment, the screen or display device is in the user's field of view or field of vision. In at least one embodiment, the information is presented as augmented reality, where the information is displayed in an overlay over the objects that the viewer is currently viewing, where the overlay still allows the user to view the objects behind the overlay.

The user views an object and at the same time, the camera or sensor of the wearable device also views the object. The camera or sensor transmits an image of the object to a controller for identification. The controller is in communication with at least one image recognition module or system. The image recognition module or system determines if the image matches a visual trigger, which is an image that indicates the start of a process. Once the visual trigger is recognized, the controller begins to watch for the first step in the process. Additional images from the wearable device are routed to the image recognition module. The image recognition module compares those images to the first step in the process. When an image matches the first step, then the controller has the image recognition module watch for the second step and continues through the process. Until the final step in the process is recognized.

In some embodiments, the image recognition module receives an image and returns a number or code indicating which step has been recognized. In some embodiments, the controller can determine that the process has started based on receiving an indicator for the first and second steps, even if the visual trigger (step 0) was not recognized. In some embodiments, there are a plurality of visual triggers for a plurality of different processes. Furthermore, some processes include one or more parallel steps that could be performed. For example, a process for attaching a cable could be slightly different for the left or right side of a device.

Described herein are computer systems such as the inspection controller and related computer systems. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As used herein, a processor can include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Wash.). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, Calif.). In yet a further example, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some examples, the system includes multiple components distributed among a plurality of computer devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present examples can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The systems and processes are not limited to the specific examples described herein. In addition, components of each system and each process can be practiced independent and separate from other components and processes described herein. Each component and process also can be used in combination with other assembly packages and processes.

The patent claims at the end of this document are not intended to be construed under 35 U.S.C. § 112(f) unless traditional means-plus-function language is expressly recited, such as “means for” or “step for” language being expressly recited in the claim(s).

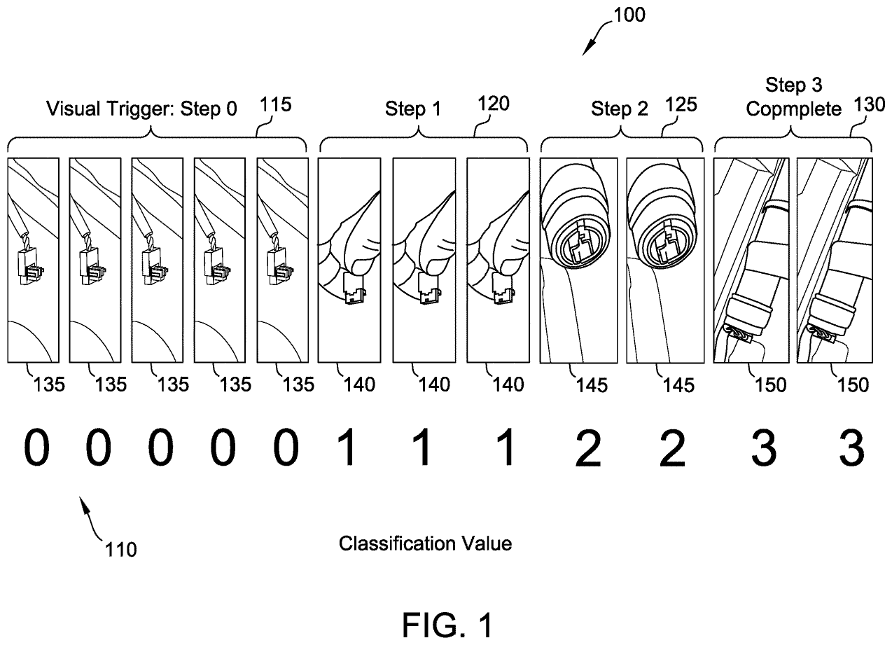

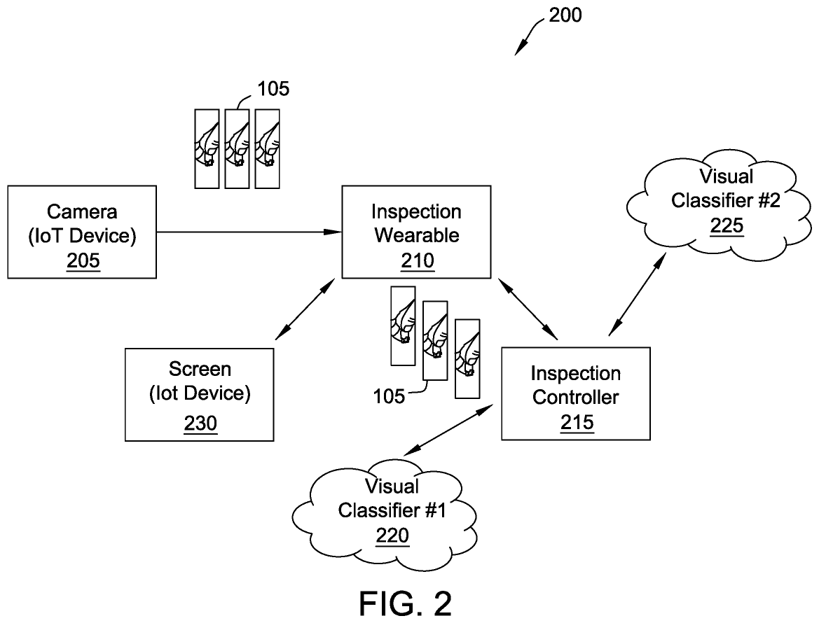

FIG. 1 illustrates an inspection system training set 100 for inspecting during installation of a part in accordance with one example of the present disclosure. The inspection system training set 100 is an example training set use to train the system 200 (shown in FIG. 2). The training set 100 includes a plurality of images 105 and an associated plurality of classification codes 110, where each image 105 of the plurality of images 105 is associated with a classification code 110 of the plurality of classification codes 110.

In the example training set 100 the plurality of images 105 are each associated with a step of a process. In the process shown in FIG. 1, there are three steps, and a step zero. However, different processes can have different numbers of steps, steps that can be performed in multiple orders, mutually exclusive steps, and steps that can be performed in parallel. In this example, the process includes a step zero 115 (also known as a visual trigger 115), a first step 120, a second step 125, and a third step 130 (or final step 130).

The training set 100 includes a plurality of visual trigger images 135, a plurality of first step images 140, a plurality of second step images 145, and a plurality of final step images 150. Each set of images 105 includes images of different views of the expected objects in the step. For example, the visual trigger images 135 include a plurality of views of a first coupler at a plurality of different angles and lighting conditions that is the start of the process. The first step images 140 include a plurality of views of a hand grabbing or holding the first coupler. The different first step images 140 could include different hands and/or having the hands hold the first coupler at different angles. The second step images 145 include a second coupler that the first coupler will be connected to. The final step images 150 include the connected first coupler and second coupler.

Each one of the images 105 includes a classification code 110. The classification code 110 indicates which of the steps and the visual trigger, that the corresponding image 105 is a part of. The training set 100 can be used for supervised training of an inspection system, such as system 200. When the system 200 is in use, the system 200 can then return the classification codes 110 for the received image.

In the exemplary embodiment, the system 200 returns a classification code 110 based on the received image 105. In some embodiments, the system 200 returns a confidence percentage along with the classification code 110. The confidence percentage represents the amount of confidence that the image represents the step.

In the exemplary embodiment, the training set 100 is composed of individual static images 105 of each step at a plurality of different angles, lighting conditions, and other factors to train the system 200 to recognize each of the different sets. By training with static images 105, the system 200 can more quickly be trained and respond when analyzing images 105 more quickly.

FIG. 2 illustrates a block diagram of the inspection system 200 for use with the training set 100 (shown in FIG. 1) in accordance with one example of the present disclosure. In the exemplary embodiment, the inspection system 200 includes a camera 205 or other IoT device for capturing images 105 (shown in FIG. 1). The camera 205 is mounted on an inspection wearable device 210. The camera 205 is configured to capture the view in the direction that the user is viewing. The inspection wearable device 210 allows the user/wearer to control where the camera 205 is pointing and what images 105 the camera 205 is capable of capturing. In at least one embodiment, the inspection wearable device 210 is a helmet or other head-worn object, upon which the camera 205 is mounted. In other embodiments, the inspection wearable device 210 can be a set of IoT glasses or goggles, with a built-in camera 205. The inspection wearable device 210 includes an attachment system, such as a helmet, headband, straps, or other arrangement to secure the inspection wearable device 210 to the wearer.

In the exemplary embodiment, the inspection system 200 also includes an inspection controller 215. The inspection controller 215 is configured to receive and route information to and from one or more inspection wearable device 210. For example, a plurality of users may be the inspection wearable devices 210, where each user of the plurality of users is working at a different location of an assembly line, such as an assembly line for a vehicle or other device. Each user has one or more processes that they must complete as their part of the assembly line. The inspection controller 215 can receive images 105 from those associated inspection wearable devices 210 and return classification codes 110 (shown in FIG. 1) for the received images 105, thereby tracking the processes that each of the users is performing. In some embodiments, the inspection controller 215 is a part of the inspection wearable device 210. In other embodiments, the inspection controller 215 is separate from the inspection wearable device 210.

In the exemplary embodiment, the inspection controller 215 is in communication with one or more visual classifiers 220 and 225 (also known as visual classifier servers 220 and 225). The visual classifiers 220 and 225 are trained to recognize images 105 and return classification codes 110, such as through the use of the training set 100 (shown in FIG. 1). In some embodiments, different visual classifiers 220 & 225 are configured to recognize images 105 from different processes. In other embodiments, a first visual classifier 220 is configured to recognize the visual trigger 115, while the second visual classifier 225 is configured to recognize the other steps 120, 125, and 130 of the process. In still other embodiments, the inspection controller 215 routes the images 105 to the visual classifiers 220 and 225 and then determines which classification code 110 to return based on the two or more responses.

In some further embodiments, the inspection controller 215 tracks which step that each of the users is on. In some of these embodiments, the controller 215 moves the user to the next step in the process when a plurality of images 105 have returned a plurality of classification codes 110 for the corresponding next step. The number of classification codes 110 required to move to the next step can be based on the speed of capturing images 105 for the camera 205. For example, the more quickly that the camera 205 captures images the more images 105 needed to advance a step.

In the exemplary embodiment, the camera 205 continually captures images 105. The inspection wearable device 210 receives the images 105 from the camera 205. The inspection wearable device 210 routes the images 105 to the inspection controller 215. The inspection controller 215 routes the images to one or more of the visual classifiers 220 and 225. The visual classifiers 220 and 225 analyze the images 105 and determine classification codes 110 for the images 105. If the image 105 does not match a known step, for example, the user is moving their head from looking at one object to another object, such as between Step 1 120 and Step 2 125 (both shown in FIG. 1), then the visual classifier 220 or 225 returns an unclassified code. The visual classifier 220 or 225 returns the classification code 110 determined for the image to the inspection controller 215.

In some embodiments, the inspection system 200 further includes a screen 230 or other feedback device attached to the inspection wearable device 210. The screen 230 can provide and display feedback to the user of the inspection wearable device 210. For example, when the inspection controller 215 determines that Step 3 130 (shown in FIG. 1) is complete, then the inspection controller 215 can transmit a message to the inspection wearable device 210 to provide feedback to the user that the process is completed successfully. The inspection wearable device 210 instructs the screen 230 to display a process complete message and/or provide an audio indication that the process is complete.

In some further embodiments, the screen 230 displays instructions to assist the user in performing the process. For example, the screen 230 could be configured to display an overlay, such as an augmented reality overlay, to display an graphic, instructions, or other information to let the user know at least one of, but not limited to, which step that the user is on, what step is next, where to look for the object for the next step, highlighting or otherwise visually indicating one or more of the objects that are a part of the process, and/or showing the completed piece after the process is complete.

In inspection system 200, the camera 205 receives visual signals about the actions of a user. In some embodiments, the camera 205 includes one or more additional sensors, such as, but not limited to, proximity sensors, visual sensors, motion sensors, audio sensors, temperature sensors, RFID sensors, weight sensors, and/or any other type of sensor that allows the inspection system 200 to operate as described herein. Camera 205 connects to one or more of inspection wearable device 210 and/or inspection controller 215 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. Camera 205 and other sensors receive data about the activities of the user or system and report those actions ultimately to the inspection controller 215.

In the example embodiment, inspection wearable devices 210 include computers that include a web browser or a software application, which enables inspection wearable devices 210 to communicate with inspection controller 215 using the Internet, a local area network (LAN), or a wide area network (WAN). In some examples, the inspection wearable devices 210 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Inspection wearable devices 210 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. Inspection wearable devices 210 can include, but are not limited to, goggles, glasses, helmets, hats, headbands, collars, and/or any other device that will allow system 200 to perform as described.

In the example embodiment, inspection controller 215 includes computers that include a web browser or a software application, which enables inspection controller 215 to communicate with one or more inspection wearable devices 210 using the Internet, a local area network (LAN), or a wide area network (WAN). Inspection controller 215 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Inspection controller 215 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In the exemplary embodiment, the inspection controller 215 is also in communication with one or more visual classifiers 220 and 225.

In the exemplary embodiment, visual classifiers 220 and 225 include a computer system in communication with one or more databases that store date. In the exemplary embodiment, the visual classifiers 220 & 225 execute one or more machine learning models that allow the visual classifiers 220 and 225 to recognize and classify images 105. In these embodiments, the visual classifiers 220 & 225 are capable of receiving images 105, analyzing those images 105, and returning a classification code 110 for those images 105. In some embodiments, the visual classifiers 220 & 225 are also able to continually learn while executing and analyzing images 105. For example, a visual classifier 220 may learn one or more images 105 that will be received while the user is moving their head and the corresponding camera 205 from looking at Step One 120 to looking at Step Two 125. In at least one embodiment, the database includes a plurality of images 105 and their corresponding classification codes 110, a plurality of additional information about the processes, and feedback information to provide to users. In some examples, the database is stored remotely from the inspection controller 215. In some examples, the database is decentralized. In at least one embodiment, a person can access the database via a client system by logging onto inspection controller 215.

In the example embodiment, screen 230 is a display device associated with the wearable inspection device 210. In some embodiments, the screen 230 is capable of projecting images into the user's field of vision or field of view. In other embodiments, the user needs to focus to view the screen 230, such as by looking downward. In some further embodiments, screen 230 is a projector that projects graphics and/or other images directly onto the objects that the user is viewing. Screen 230 connects to one or more of inspection wearable device 210 and/or inspection controller 215 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines.

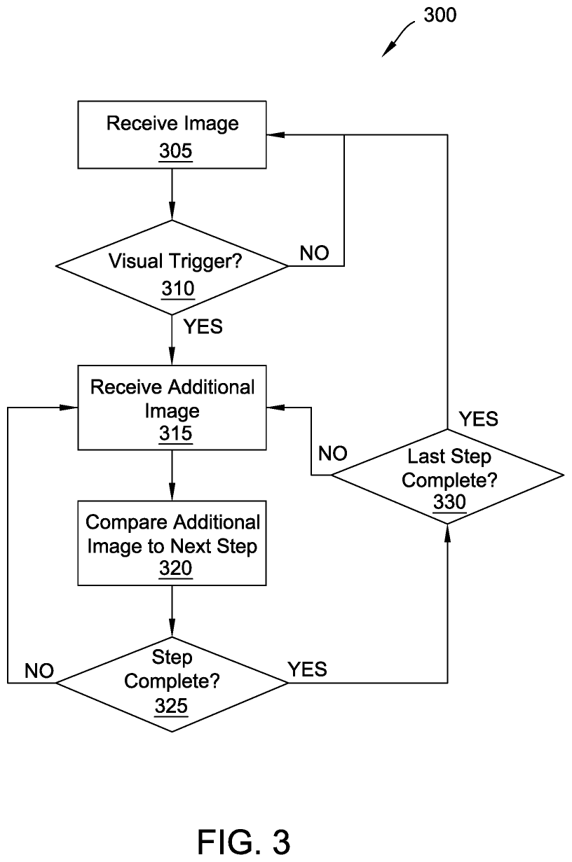

FIG. 3 illustrates a process 300 for using the inspection system 200 (shown in FIG. 2), in accordance with at least one example. Process 300 is implemented by the inspection controller 215 (shown in FIG. 2).

In the exemplary embodiment, the inspection controller 215 receives 305 an image 105 (shown in FIG. 1). The inspection controller 215 determines 310 if the image 105 is the visual trigger 115. In the exemplary embodiment, the inspection controller 215 routes the image 105 to one or more visual classifiers 220 & 225 to determine the classification code 110 for the image 105. If the classification code 110 that is returned indicates that the image 105 is the visual trigger 115, then inspection controller 215 moves to Step 315, otherwise the inspection controller 215 returns to Step 305. In some embodiments, the inspection controller 215 waits until a threshold number of consecutive classification codes 110 are returned indicating the visual trigger 115 before moving to Step 315.

In the exemplary embodiment, the inspection controller 215 receives 315 an additional image 105. The inspection controller 215 passes the additional image 105 to the visual classifier 220 or 225 and receives a classification code 110 for the additional image 105. The inspection controller 215 compares 320 the received classification code 110 to determine 325 if the current step is complete. For example, the image 105 can be for the previously completed step, as the user has not started or completed the next test. If the inspection controller 215 determines 325 that the step is not complete, then the inspection controller 215 returns to Step 315. If the inspection controller 215 determines 325 that the step is complete, the inspection controller 215 determines 330 if the last step 130 (shown in FIG. 1) is complete. If the last step 130 is complete, the inspection controller 215 returns to Step 305 to wait for the next visual trigger 115. In some embodiments, the inspection controller 215 instructs the inspection wearable device 210 to provide feedback to the user that the process has completed successfully. For example, the inspection wearable device 210 can cause the screen 230 to display a process complete message or have an audible message, such as a beep or tone, play to indicate that the process is complete and whether or not the process was successful. If the last step 130 is not complete, the inspection controller 215 returns to Step 315 for the next step.

As described herein, the inspection system 200 begins recording when an image 105 of a visual trigger 115 is captured by the camera 205. The inspection controller 215 begins the process of watching for each step. When an image 105 of a step is recognized, the inspection controller 215 moves to the next step. The inspection controllers 215 then can provide feedback when the process is complete. The feedback can include a Yes or No that the process is completed successfully, a percentage of complete, or any other indicator of how well the process was completed. In at least one embodiment, the feedback can include instructions to fix any issue with the current product.

In some further embodiments, process 300 can be reset to Step 305 by the user. In at least one of these embodiments, the user presses a button or makes an audible comment, i.e., “Reset, Reset, Reset,” to stop process 300 and return to Step 305. Furthermore, the inspection controller 215 can determine that the user accidentally pointed the camera 205 at the visual trigger 115 and that the user is not performing the process. The inspection controller 215 can make this determination if the first step 120 object is not viewed for a predetermined period of time. Or if a different visual trigger 115 for a different process is viewed next.

In at least one embodiment, the inspection controller 215 is looking for an image 105 that matches the next step rather than continuous video. For example, using the classification codes shown in FIG. 1, the inspection controller 215 receives 305 an image 105 for which the visual classifier 220 determines the classification code is 0, which represents the visual trigger 115. Next, the inspection controller 215 receives 315 additional images 105 until the classification code 110 comes back as 1 for Step One 120. Then the inspection controller 215 receives 315 additional images 105 until the classification code 110 comes back as 2 for Step Two 125. Then the inspection controller 215 receives 315 additional images 105 until the classification code 110 comes back as 3 for Step Three or the Final Step 130. If after receiving the classification code 110 for Step Two 125, the inspection controller 215 receives 315 an additional image 105 that classifies as Step One 120, such as when the user looks back at the coupler that is in their hand, the inspection controller 215 drops or ignores the new Step One 120 classification code 110.

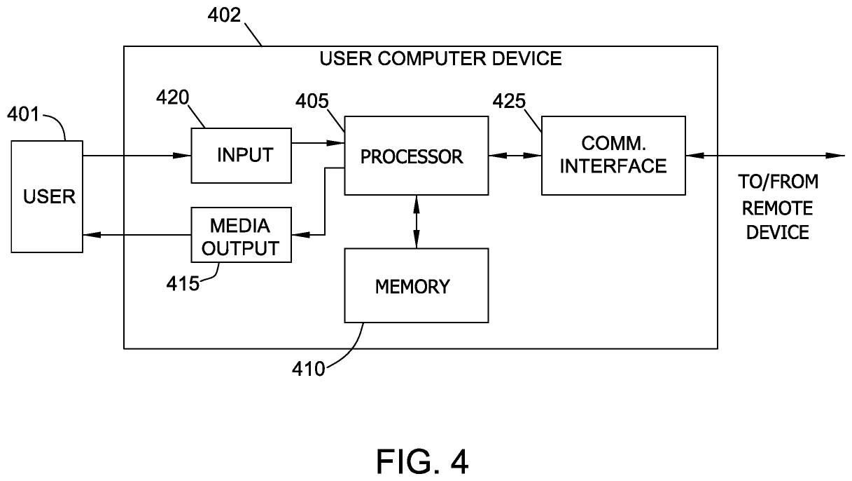

FIG. 4 illustrates an example configuration of user computer device 402 used in the inspection system 200 (shown in FIG. 2), in accordance with one example of the present disclosure. User computer device 402 is operated by a user 401. The user computer device 402 can include, but is not limited to, camera 205, inspection wearable device 210, inspection controller 215, visual classifiers 220 & 225, and screen 230 (all shown in FIG. 2). The user computer device 402 includes a processor 405 for executing instructions. In some examples, executable instructions are stored in a memory area 410. The processor 405 can include one or more processing units (e.g., in a multi-core configuration). The memory area 10 is any device allowing information such as executable instructions and/or transaction data to be stored and retrieved. The memory area 410 can include one or more computer-readable media.

The user computer device 402 also includes at least one media output component 415 for presenting information to the user 401. The media output component 415 is any component capable of conveying information to the user 401. In some examples, the media output component 415 includes an output adapter (not shown) such as a video adapter and/or an audio adapter. An output adapter is operatively coupled to the processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some examples, the media output component 415 is configured to present an augmented reality overlay to the user 401. An augmented reality overlay can include, for example, an overlay that provides information about the objects that the user is currently viewing. In some examples, the user computer device 402 includes an input device 420 for receiving input from the user 401, such as the camera 205. The user 401 can use the input device 420 to, without limitation, capture an image 105 of what the user 401 is currently viewing. The input device 420 can include, for example, a keyboard, a pointing device, a mouse, a stylus, a touch sensitive panel (e.g., a touch pad or a touch screen), a gyroscope, an accelerometer, a position detector, a biometric input device, one or more optical sensors, and/or an audio input device. A single component such as a touch screen can function as both an output device of the media output component 415 and the input device 420.

The user computer device 402 can also include a communication interface 425, communicatively coupled to a remote device such as the inspection controller 215, one or more cameras 205, and one or more screens 230. The communication interface 425 can include, for example, a wired or wireless network adapter and/or a wireless data transceiver for use with a mobile telecommunications network.

Stored in the memory area 410 are, for example, computer-readable instructions for providing a user interface to the user 401 via the media output component 415 and, optionally, receiving and processing input from the input device 420. A user interface can include, among other possibilities, a web browser and/or a client application. Web browsers enable users, such as the user 401, to display and interact with media and other information typically embedded on a web page or a website from the inspection controller 215. A client application allows the user 401 to interact with, for example, the inspection controller 215. For example, instructions can be stored by a cloud service, and the output of the execution of the instructions sent to the media output component 415.

The processor 405 executes computer-executable instructions for implementing aspects of the disclosure, such as process 300 (shown in FIG. 3).

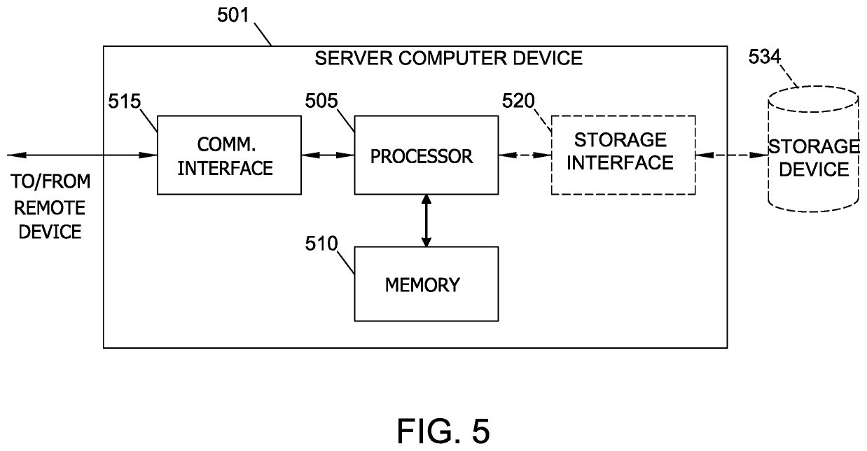

FIG. 5 illustrates an example configuration of a server computer device 501 used in the inspection system 200 (shown in FIG. 2), in accordance with one example of the present disclosure. Server computer device 501 can include, but is not limited to, the inspection controller 215 and visual classifiers 220 and 225 (all shown in FIG. 2). The server computer device 501 also includes a processor 505 for executing instructions. Instructions can be stored in a memory area 510. The processor 505 can include one or more processing units (e.g., in a multi-core configuration).

The processor 505 is operatively coupled to a communication interface 515 such that the server computer device 501 is capable of communicating with a remote device such as another server computer device 501, another inspection controller 215, or one or more inspection wearable devices 210 (shown in FIG. 2). For example, the communication interface 515 can receive requests from a client system via the Internet.

The processor 505 can also be operatively coupled to a storage device 534. The storage device 534 is any computer-operated hardware suitable for storing and/or retrieving data, such as, but not limited to, data associated with the database. In some examples, the storage device 534 is integrated in the server computer device 501. For example, the server computer device 501 can include one or more hard disk drives as the storage device 534. In other examples, the storage device 534 is external to the server computer device 501 and can be accessed by a plurality of server computer devices 501. For example, the storage device 534 can include a storage area network (SAN), a network attached storage (NAS) system, and/or multiple storage units such as hard disks and/or solid-state disks in a redundant array of inexpensive disks (RAID) configuration.

In some examples, the processor 505 is operatively coupled to the storage device 534 via a storage interface 520. The storage interface 520 is any component capable of providing the processor 505 with access to the storage device 534. The storage interface 520 can include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 505 with access to the storage device 534.

The processor 505 executes computer-executable instructions for implementing aspects of the disclosure. In some examples, the processor 505 is transformed into a special purpose microprocessor by executing computer-executable instructions or by otherwise being programmed. For example, the processor 505 is programmed with instructions such as those shown in FIG. 3.

The methods and system described herein can be implemented using computer programming or engineering techniques including computer software, firmware, hardware, or any combination or subset. As disclosed above, there is a need for systems providing a cost-effective and reliable manner for customizing surfaces. The system and methods described herein address that need. Additionally, this system: (i) allows hands-free inspection of manufacturing processes; (ii) allows inspection of hard to reach and/or hard to see locations; (iii) prevents inspection systems from getting in the way of users; (iv) provides real-time feedback on manufacturing process; and (v) assists the user in determining the status of any manufactured and/or installed part.

The methods and systems described herein can be implemented using computer programming or engineering techniques including computer software, firmware, hardware, or any combination or subset thereof, wherein the technical effects can be achieved by performing at least one of the following steps: a) receive a signal from the at least one sensor including a current image in the view of the user; b) compare the current image to a trained inspection model to determine a classification code based on the comparison; c) determine a current step of a process being performed by the user based on the classification code; d) provide a notification message to the user via the media output component based on the current step of the process being performed by the user; e) display an augmented reality overlay to the user; f) display an instruction for the current step to the user via the augmented reality overlay; g) display feedback associated with a completed step via the augmented reality overlay; h) receive a first image from the at least one sensor; i) determine a first step associated with the first image; j) subsequently receive a second image from the at least one sensor; k) determine a second subsequent step associated with the second image; l) receive a plurality of images each associated with a classification code; m) train an inspection model using the plurality of images and the associated plurality of classification codes; n) determine if the part was properly installed based on the current image; and o) provide feedback based on whether or not the part was properly installed.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, and telematics data. ML outputs may include but are not limited to: digital signals (e.g. information data converted from natural phenomena). ML outputs may further include: speech recognition, image or video recognition, medical diagnoses, statistical or financial models, autonomous vehicle decision-making models, robotics behavior modeling, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with different images and their corresponding classifications, generate a model which maps the image data to the classification data, and recognize future images and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data comprising event data, financial data, social data, geographic data, cultural data, and political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose various implementations, including the best mode, and also to enable any person skilled in the art to practice the various implementations, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wearable inspection unit comprising:
at least one sensor configured to capture images based on a current view of a user;
a media output component configured to display an augmented reality overlay to the user; and
a controller comprising at least one processor in communication with at least one memory device, and wherein the controller is in communication with the at least one sensor and the media output component, wherein the at least one processor is programmed to:
store a machine learning trained inspection model, wherein the trained inspection model is trained to recognize images of one or more components;
receive a signal from the at least one sensor including a current image in the current view of the user;
compare the current image to the trained inspection model to determine a classification code based on the comparison;
determine a current step of a process being performed by the user based on the classification code; and
provide a notification message to the user via augmented reality overlay based on the current step of the process being performed by the user.

2. The wearable inspection unit of claim 1, wherein the media output component is configured to display an instruction for the current step to the user via the augmented reality overlay.

3. The wearable inspection unit of claim 1, wherein the at least one processor is further programmed to display feedback associated with the current step via the augmented reality overlay.

4. The wearable inspection unit of claim 1, wherein the at least one sensor configured to capture images or video based on the current view of the user.

5. The wearable inspection unit of claim 1, wherein the at least one processor is further programmed to:
receive a first image from the at least one sensor;
determine a first step associated with the first image;
subsequently receive a second image from the at least one sensor; and
determine a second subsequent step associated with the second image.

6. The wearable inspection unit of claim 1, wherein the at least one processor is further programmed to:
receive a plurality of images each associated with a classification code; and
train an inspection model using the plurality of images and the associated plurality of classification codes to determine a classification code based on an image.

7. The wearable inspection unit of claim 1, wherein the process is installation of a part, and wherein the at least one processor is further programmed to:
determine if the part was properly installed based on the current image; and
provide feedback based on whether or not the part was properly installed via the augmented reality overlay.

8. The wearable inspection unit of claim 1, further comprising an attachment system for attaching the wearable inspection unit to the user.

9. A system comprising:
a wearable comprising at least one sensor configured to capture images based on a current view of a wearer;
a media output component configured to display an augmented reality overlay to the wearer; and
a controller in communication with the wearable, wherein the controller comprises at least one processor in communication with at least one memory device, wherein the at least one processor programmed to:
store a machine learning trained inspection model, wherein the trained inspection model is trained to recognize images of one or more components;
receive a signal from the at least one sensor including a current image in the current view of the wearer;
compare the current image to the trained inspection model to determine a classification code based on the comparison;
determine a current step of a process being performed by the wearer based on the classification code; and
provide a notification message to the wearer via the augmented reality overlay based on the current step of the process being performed by the wearer.

10. The system of claim 9, wherein the at least one processor is further programmed to instruct the wearable to display an instruction for the current step to the wearer via the augmented reality overlay.

11. The system of claim 9, wherein the at least one processor is further programmed to display feedback associated with a completed step via the augmented reality overlay.

12. The system of claim 9, wherein the at least one processor is further programmed to:
receive a first image from the at least one sensor;
determine a first step associated with the first image;
subsequently receive a second image from the at least one sensor; and
determine a second subsequent step associated with the second image.

13. The system of claim 9, wherein the at least one processor is further programmed to:
receive a plurality of images each associated with a classification code; and
train an inspection model using the plurality of images and the associated plurality of classification codes to determine a classification code based on an image.

14. The system of claim 9, wherein the process is installation of a part, and wherein the at least one processor is further programmed to:
determine if the part was properly installed based on the current image; and
provide feedback based on whether or not the part was properly installed via the augmented reality overlay.

15. The system of claim 9, wherein the controller is in communication with a visual classifier server, and wherein the at least one processor is further programmed to:
transmit the current image to the visual classifier server; and
receive the classification code from the visual classifier server.

16. A method for inspecting, the method implemented by an inspection computing device comprising at least one processor in communication with at least one memory device, wherein the process comprises:
storing a machine learning trained inspection model, wherein the trained inspection model is trained to recognize images of one or more components;
receiving a signal from at least one sensor including a current image in a current view of a user;
comparing the current image to the trained inspection model to determine a classification code based on the comparison;
determining a current step of a process being performed by the user based on the classification code; and
providing a notification message to the user via an augmented reality overlay based on the current step of the process being performed by the user.

17. The method of claim 16 further comprising displaying an instruction for the current step to the user via the augmented reality overlay.

18. The method of claim 16 further comprising displaying feedback associated with the current step via the augmented reality overlay.

19. The method of claim 16 further comprising:
receiving a plurality of images each associated with a classification code; and
training an inspection model using the plurality of images and the associated plurality of classification codes to determine a classification code based on an image.

20. The method of claim 16 further comprising:
receiving a first image from the at least one sensor;
determining a first step associated with the first image;
subsequently receiving a second image from the at least one sensor; and
determining a second subsequent step associated with the second image.
